(19) United States
(12) Patent Application Publication
(10) Pub. No.: US 2025/0059777 A1
(43) Pub. Date: Feb. 20, 2025

(54) Underlayment Assembly

(71) Applicant: Novalis Holdings Limited, Hong Kong (CN)

(72) Inventors: Graham Capobianco, Millersville, PA (US); Andy McWilliams, Benton, TN (US)

(73) Assignee: Novalis Holdings Limited, Hong Kong (CN)

(21) Appl. No.: 18/450,163

(22) Filed: Aug. 15, 2023

(51) Int. Cl. E04F 15/20; B32B 3/06; B32B 3/12; B32B 3/30; B32B 7/02; B32B 7/12; B32B 27/06; B32B 27/20; B32B 27/30

(52) U.S. Cl. CPC E04F 15/206; B32B 3/06; B32B 3/12; B32B 3/30; B32B 7/02; B32B 7/12; B32B 27/06; B32B 27/20; B32B 27/304; B32B 2264/104; B32B 2264/303; B32B 2307/102; B32B 2307/558; B32B 2307/718; B32B 2307/72; B32B 2307/734; B32B 2307/7376; B32B 2419/04; E04F 2201/0146; E04F 2201/023; E04F 2201/042; E04F 2201/043; E04F 2290/041

(57) ABSTRACT

An underlayment assembly is provided and generally includes an upper surface, an acoustical section, and a locking system. The upper surface section includes a top surface having an embossed texture with an embossed depth positioned on the upper surface section. The acoustical section having an acoustical layer secured to a bottom portion of the upper surface section by an adhesive layer having a cell structure underlayment with a closed cell honeycomb structure.

### FIELD OF THE INVENTION

The present invention relates to an underlayment assembly and, more particularly, a polymeric, high density, rigid, interlocking product with a versatile functionality as an underlayment for floor coverings.

### BACKGROUND

As the multi-family housing and hospitality markets have continued to expand, the demand for flooring products that reduce the transmission of structure-borne sound (i.e., dropped objects, moving furniture, heavy footsteps) and airborne sound (i.e., televisions, music, loud speech) in living spaces has grown. In fact, many states/provinces, municipalities and general contractors/builders have established minimum requirements for impact sound insulation ratings (IIC, per the ASTM E413 Classification for Rating Sound Insulation) and airborne sound insulation ratings (STC, per the ASTM E989 Standard Classification for Determination of Single-Number Metrics for Impact Noise). Unlike carpet products, many resilient flooring products, such as Luxury Vinyl Tile (LVT), Loose Lay Tile (LLT), cannot meet building IIC and STC requirements without the inclusion of an acoustical sound-reducing underlayment. However, residential and hospitality design trends have shifted away from carpet in favor of resilient flooring, which offers a wide array of designs and is easier to clean, disinfect and deodorize than carpet.

To increase the sound reduction Luxury Vinyl Tile (LVT) and Loose Lay Tile (LLT) products, a separate sound control underlayment is often installed beneath LVT or LLT. This underlayment is usually made of a soft material (i.e., recycled rubber, foam, cork blend) and glued down with a compatible adhesive, effectively making it a two-step process that can complicate flooring installation. Additionally, the inclusion of a soft underlayment can dramatically reduce the indentation resistance of LVT and LLT, resulting in unsightly indentations from furniture or furniture feet—this can often cause an unpleasant appearance or permanent damage to the finished floor in some cases.

In addition to sound reduction, there are many other requirements for satisfactory flooring installations, especially with regards to substrate preparation. Often times, underlayments are used to overcome substrate surface imperfections, such as divots, minor cracks or construction joints. For wood substrates, this often means installing plywood panel underlayments, which require fastening to the subfloor. For concrete substrates, this often means applying a cementitious patch or leveling compound. However, in these cases, there are also concerns regarding elevated moisture pH levels in concrete, which can attack and breakdown patches and flooring adhesives.

Unlike other underlayments, the underlayment assembly is a uniquely versatile product that combines many of the underlayment requirements of multi-family and hospitality projects. The underlayment assembly is a floating system that doesn't require adhesive or fastening, allowing for fast and easy installation with minimal tools. The underlayment assembly can cover moderate substrate surface imperfections and cracks, providing a smooth and sound surface that accelerates installation times. With an incorporated acoustical pad, the underlayment assembly also enables fully adhered resilient flooring installations to meet the IIC and STC requirements of multi-family and hospitality buildings.

As the foregoing illustrates, the invention provides the underlayment assembly 1 to rectify the shortcomings of the previous flooring.

### SUMMARY

An underlayment assembly is provided and generally includes an upper surface, an acoustical section, and a locking system. The upper surface section includes a top surface having an embossed texture with an embossed depth positioned on the upper surface section. The acoustical section having an acoustical layer secured to a bottom portion of the upper surface section by an adhesive layer having a cell structure underlayment with a closed cell honeycomb structure and a panel having the underlayment assembly coupling to another panel by a locking system.

### BRIEF DESCRIPTION OF DRAWINGS

In the following, the present invention is described in more detail with references to the drawings in which:

FIG. 1 is a perspective view of the underlayment assembly according to the invention;

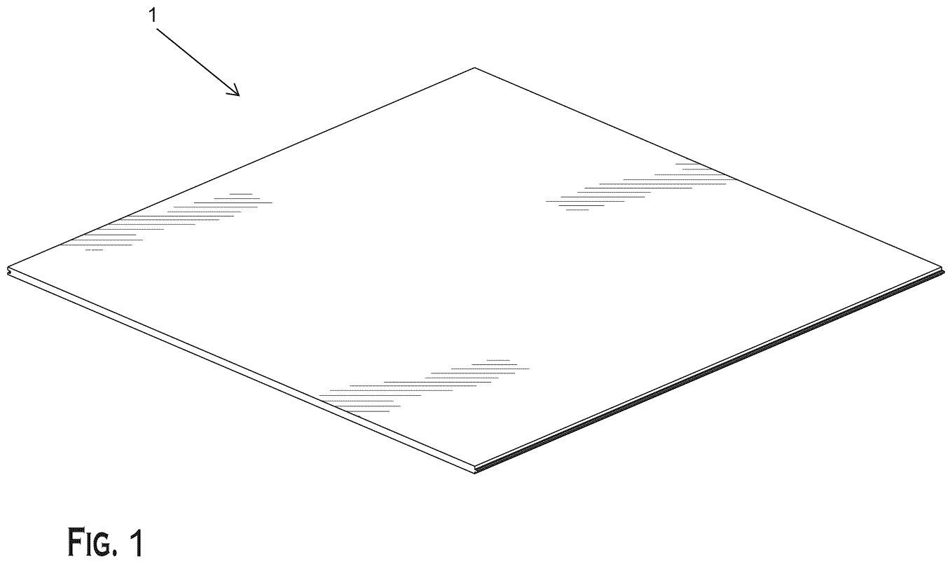

FIG. 2 is an enlarged random textured view of the invention;

FIG. 3 is another enlarged pebble appearance textured view of FIG. 2;

FIG. 4 is another enlarged wood grain textured view of FIG. 3;

FIG. 5 is a cross sectional view of the invention;

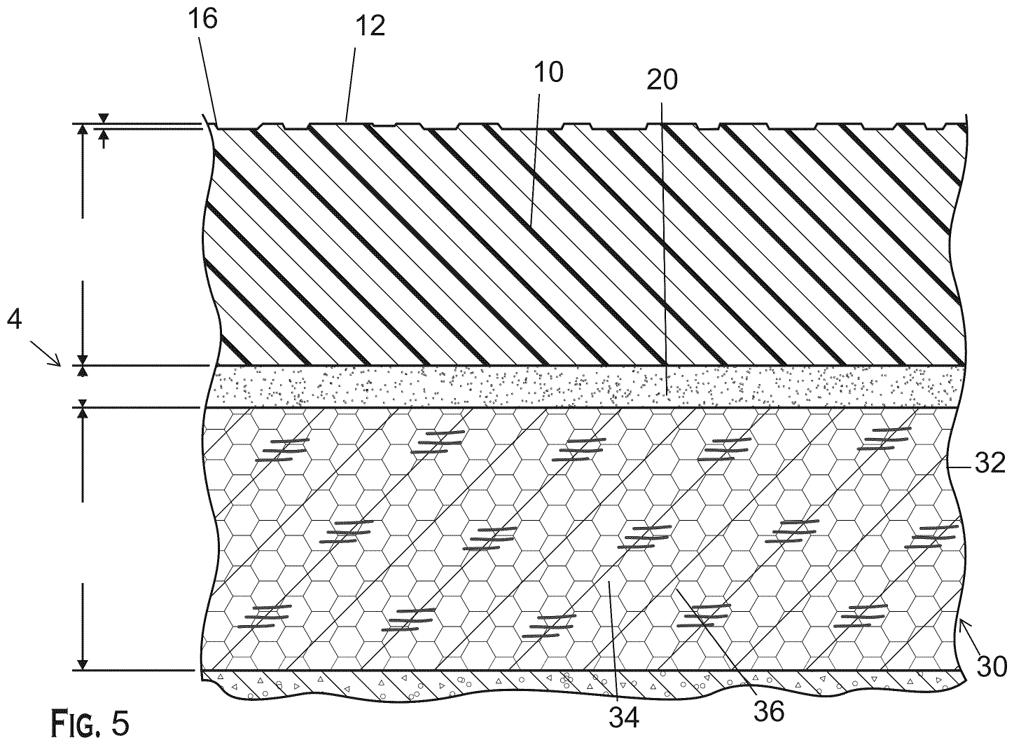

FIG. 6 is another cross sectional view of FIG. 5;

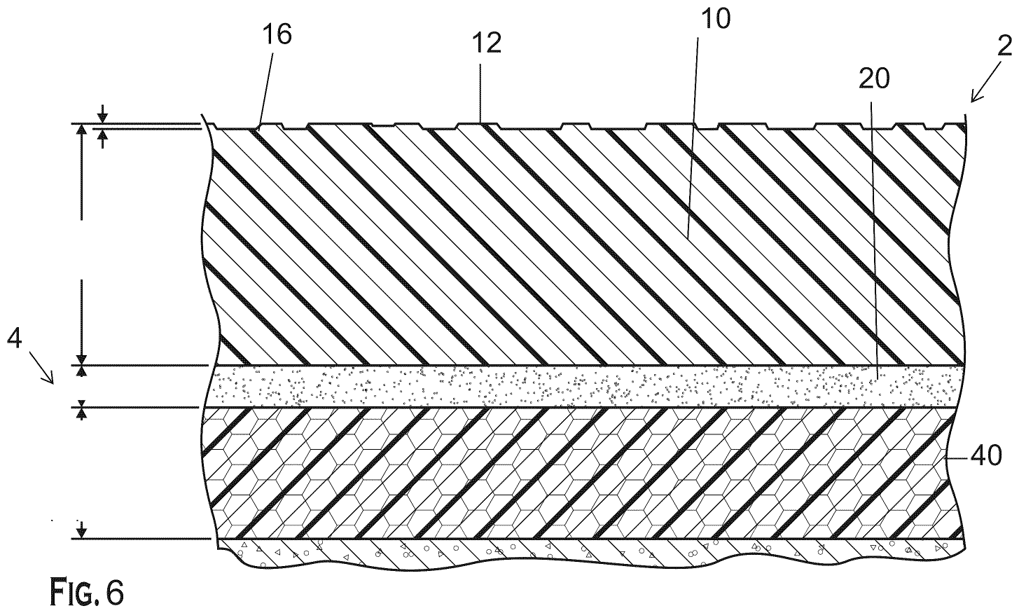

FIG. 7 is a side view of a locking system of the invention; and

FIG. 8 is a side view of another locking system of the invention of FIG. 7.

### DETAILED DESCRIPTION OF THE EMBODIMENTS

The present disclosure includes an underlayment assembly 1 according to the invention. In the exemplary embodiment, the underlayment assembly 1 generally includes an upper surface section 2, an acoustical section 4 and a locking system 6.

In the exemplary embodiment, the upper surface section 2 is a polymeric rigid core—the composition of the upper surface section 2 includes a polyvinyl chloride (PVC) resin, stabilizer, impact modifier, processing aid, calcium carbonate filler, lubricants, etc. If needed, a small amount of plasticizer can be added to lower the melted viscosity in the extruder or a blowing agent can be added to lower the density, thereby lowering the weight. It is also a common practice to add post-industrial waste and scrap, to divert waste from landfills.

In the exemplary embodiment, the upper surface section 2 includes a rigid core layer 10. As shown, the rigid core layer 10 has a thickness in the range of 3.0 mm to 8 mm. In another exemplary embodiment, the rigid core layer 10 has a thickness of 4.0-5.0 mm.

The upper surface section 2 further includes a top surface 12.

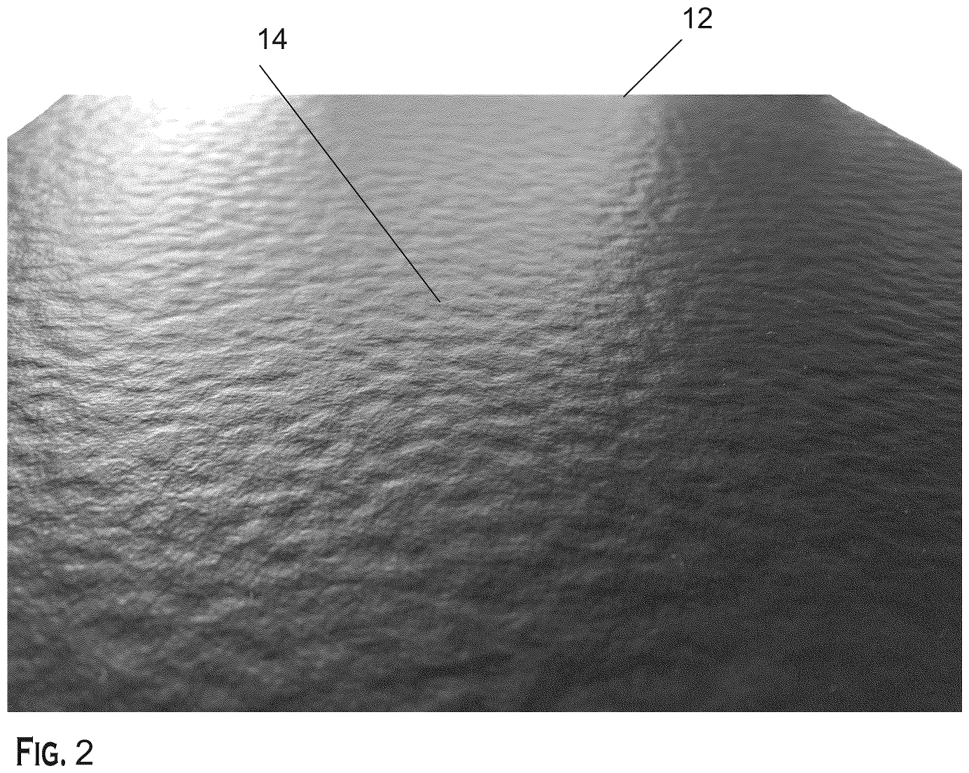

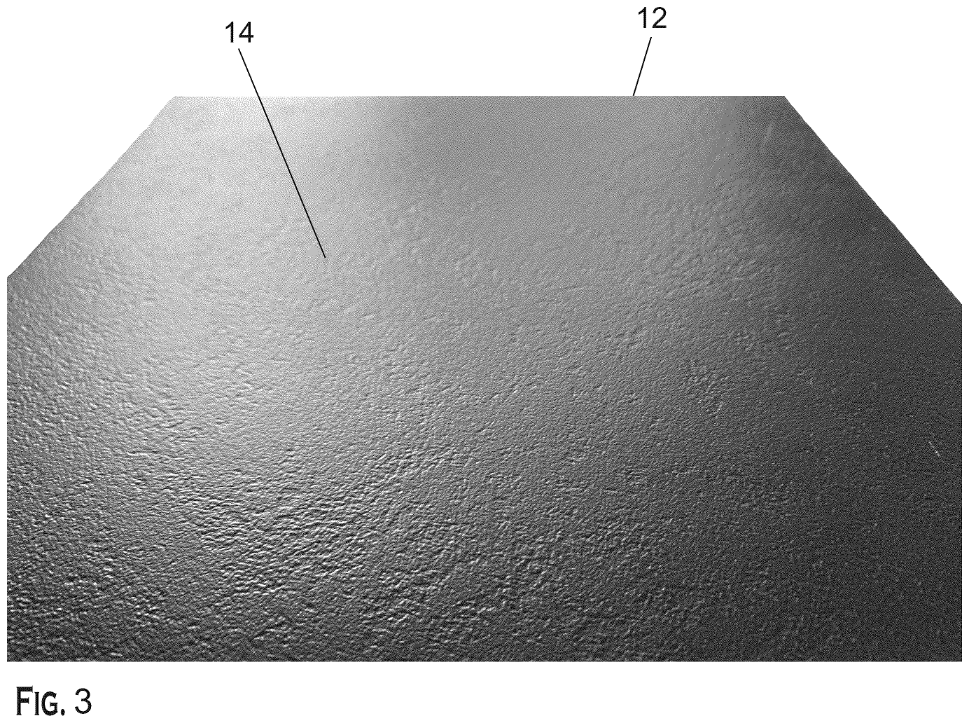

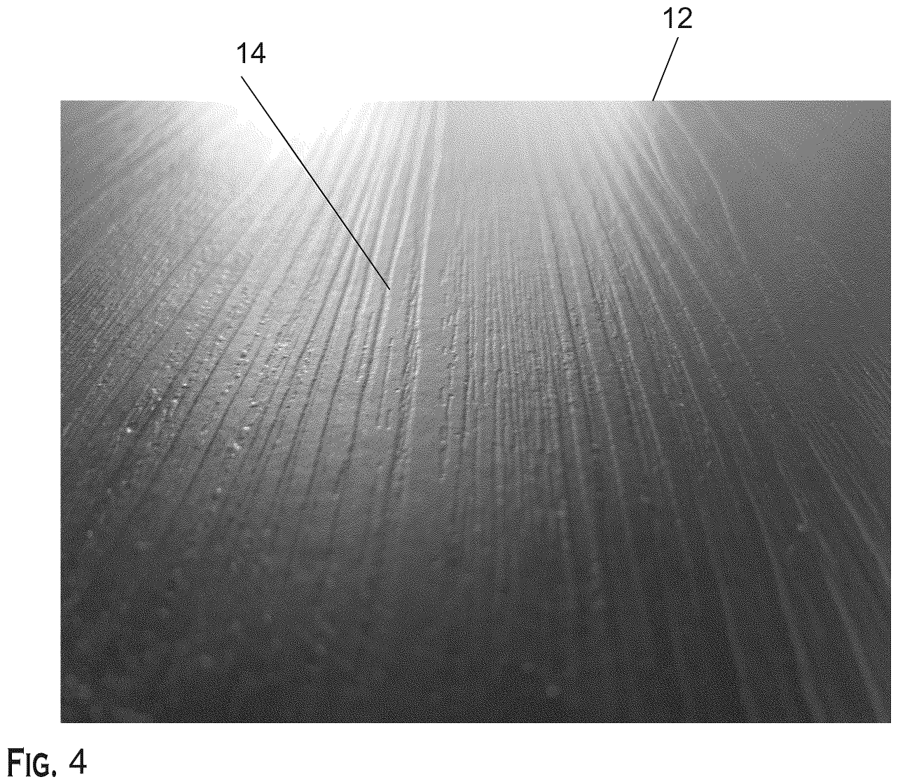

As shown in FIGS. 2-4, the top surface 12 is designed with various types of embossed textures 14, which can be an overall random, round pebble appearance, a wood grain texture, or others designs. One skilled in the art would understand the applicant's design is not the exclusive embodiment.

In the exemplary embodiment, an embossed depth 16 on the upper surface section 2 is in the range of 0.1 mm to 0.4 mm. In another exemplary embodiment, the embossed depth 16 is in the range of .105 mm to .398 mm. In another exemplary embodiment, the embossed depth 16 is in the range of .11 mm to .36 mm. The purpose of the embossed texture 14 on the surface of the upper surface section 2 is to impart additional surface areas for the adhesive to form a strong bond at the interface of the underlayment assembly 1 and subsequent LLT or LVT products.

In an exemplary embodiment, the acoustical section 4 includes an adhesive layer 20 and an acoustical layer 30.

In an exemplary embodiment, the adhesive layer 20 is a hot melt glue, such as a reactive moisture cured polyurethane glue or an ethylene vinyl acetate glue.

In an exemplary embodiment, the acoustical layer 30 is secured to a lower surface of the rigid core layer 10 by the adhesive layer 20 and is applied at a typical application rate of about 60 to about 70 gram/m². In another exemplary embodiment, the typical application rate is about 63 to about 66.5 gram/m². In another exemplary embodiment, the typical application rate is about 64 to about 65.5 gram/m². In the exemplary embodiment, the acoustical layer 30 is a low density, highly efficient layer of material made from a renewable, sustainable source, such as cork (typically the porous outer bark of Quercus suber), or a synthetic polymeric foam layer.

In an exemplary embodiment, the acoustical layer 30 includes a cell structure underlayment 32. The cell structure underlayment 32 is an ideal material for the acoustical backing material because of its unique, multi-faced, closed or open cell structure 34. For instance, in the exemplary embodiment shown, a plurality of cell walls 36 of the structure 34 are strong, tough, and tenacious; these cells are filled with air and are impermeable to liquids. Because of its cell structure, the density of the cell structure underlayment 32, such as cork or polymeric foam, is very low. When the cork or polymeric foam is compressed, the cell membranes will change shape, but not break—the cell is resilient and will return to its original shape after the compression is removed. The many tiny, sealed pockets of air in the structure 34 strongly resist the transmission of sound from vibrations caused by the impact of falling objects, walking, running, dragging furniture, or rolling objects on or across a floor. In addition to the desirable acoustical properties that cork provides to the product, cork or polymeric foam has very low thermal conductivity and has desirable chemical resistance, water impermeability, hypoallergenic properties, and fire retardancy.

In another exemplary embodiment, the acoustical layer 40 may be a synthetic polymeric foam material of polyurethane (PUR), polyvinyl chloride (PVC), ethylene vinyl acetate (EVA), polyethylene (PE), EVA/silicone, urea formaldehyde (UF), polystyrene (PS), and irradiant-crosslinked polyethylene (IXPE), or other polymeric foam with similar properties.

In the exemplary embodiment, the acoustical section 4 is lightweight and a thinner gauge than that of any other known application.

For instance, in the exemplary embodiment, the acoustical layer 30, 40 has a thickness of 1 mm or less that accounts for 30% of the total laminated product thickness of the underlayment assembly 1. In another exemplary embodiment, the acoustical layer 30, 40 has a thickness of 95 mm or less that accounts for 30% of the total laminated product thickness of the underlayment assembly 1. In another exemplary embodiment, the acoustical layer 30, 40 has a thickness of 0.9 mm or less that accounts for 30% of the total laminated product thickness of the underlayment assembly 1. In another exemplary embodiment, the acoustical layer 30, 40 has a thickness of 0.5 mm or less that accounts for 30% of the total laminated product thickness of the underlayment assembly 1.

The density of the acoustical layer 30, 40 is in the range of about 5 lb./ft³ (0.08 g/cc) to about 20 lb./ft³ (0.32 g/cc) and the thickness of the acoustical layer 30, 40 is in the range of about 1 mm (0.04 inch) to about 2 mm (0.08 inch). The acoustical layer 30, 40 is attached to the lower surface of the rigid core layer 10 using the adhesive layer 20. However, one skilled in the art should appreciate that the acoustical layer 30, 40 can be secured to the upper surface of the underlayment assembly 1 using other means.

In the exemplary embodiment, the locking system 6 of a panel 8 of the underlayment assembly 1 includes a first coupling part 50 and a second coupling part 60. The panel 8 having an upper side 8a and a lower side 8b.

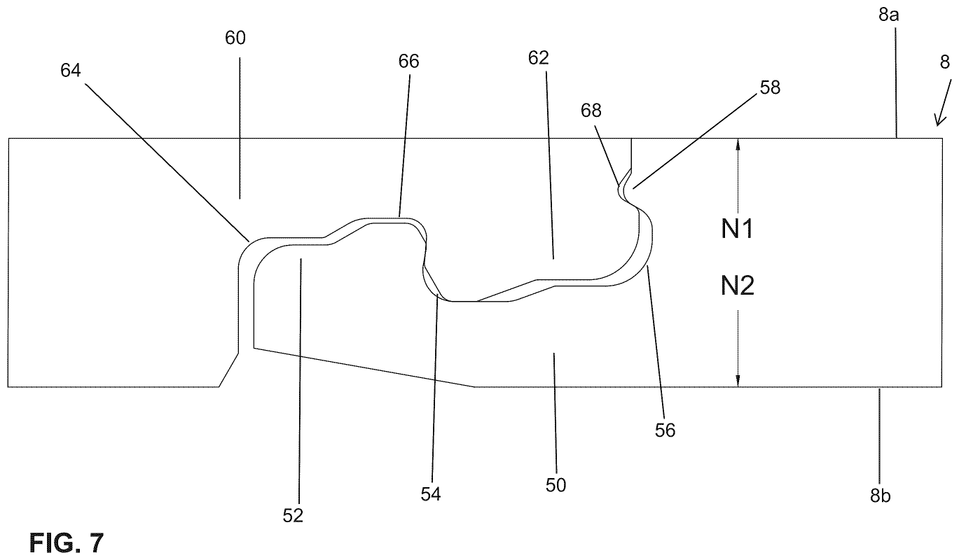

As shown in FIG. 7, the first coupling part 50 includes an upper tongue 52, a first upper groove receiver 54, a second upper groove receiver 56 and a protrusion 58.

As shown, the upper tongue 52 extends in a direction of N1 towards the upper side 8a of the panel 8.

As shown, the first upper groove receiver 54 is a depression. The first upper groove receiver 54 is positioned adjacent the upper tongue 52. One skilled in the art would understand the applicant's design is not the exclusive embodiment.

As shown, the second upper groove receiver 56 is a depression positioned adjacent the protrusion 58. One skilled in the art would understand the applicant's design is not the exclusive embodiment.

As shown, the protrusion 58 is a curvature member. The protrusion 58 extends away from the first coupling part 50. One skilled in the art would understand the applicant's design is not the exclusive embodiment.

As shown in FIG. 7, the second coupling part 60 includes a lower tongue 62, a first lower groove receiver 64, a second lower groove receiver 66 and a protrusion receiver 68.

As shown in FIG. 7, the lower tongue extends in a direction N2 towards the lower side 8b of the panel 8.

As shown, the first lower groove receiver 64 is a depression extending inward towards the second coupling part 60. The first lower groove receiver 64 is positioned adjacent the upper tongue 52. One skilled in the art would understand the applicant's design is not the exclusive embodiment.

As shown, the second lower groove receiver 66 is a depression extending inward towards the second coupling part 60. The second lower groove receiver 66 is positioned adjacent the upper tongue 52. One skilled in the art would understand the applicant's design is not the exclusive embodiment.

As shown the protrusion receiver 68 is a depression extending inward towards the second coupling part 60. The protrusion receiver 68 is adjacent the protrusion 58. One skilled in the art would understand the applicant's design is not the exclusive embodiment.

In another exemplary embodiment, the locking system 6′ of the panel 8 of the underlayment assembly 1 includes a first coupling part 70 and a second coupling part 80.

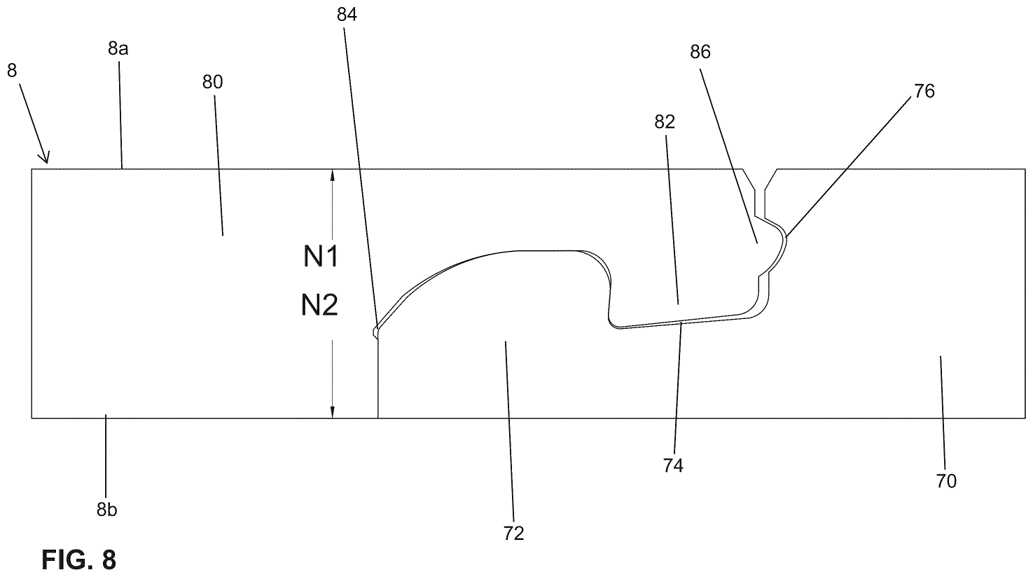

As shown in FIG. 8, the first coupling part 70 includes an upwards tongue 72, a first upwards groove 74 and a protrusion receiver 76.

As shown in FIG. 8, the first coupling part 70 includes an upwards tongue 72 extending in a direction N1.

As shown in FIG. 8, the first upwards groove 74 is a depression extending inward towards the first coupling part 70. One skilled in the art would understand the applicant's design is not the exclusive embodiment.

As shown in FIG. 8, the protrusion receiver 76 is a depression extending inward toward the first coupling part 70. The protrusion receiver 76 is adjacent the first upwards groove 74. One skilled in the art would understand the applicant's design is not the exclusive embodiment.

As shown in FIG. 8, the second coupling part 80 includes a downward tongue 82, a first downward groove receiver 84, and a protrusion 86.

As shown in FIG. 8, the downward tongue 82 extends in the N2 direction towards the lower side 8b. One skilled in the art would understand the applicant's design is not the exclusive embodiment.

As shown in FIG. 8, the first downward groove receiver 84 is a depression extending inward towards the second coupling part 80. One skilled in the art would understand the applicant's design is not the exclusive embodiment.

As shown, the protrusion 86 is a curvature member. The protrusion 86 extends away from the downward tongue 82. The protrusion 96 is adjacent the protrusion receiver 76. One skilled in the art would understand the applicant's design is not the exclusive embodiment.

A user utilizing more than one panel 8 that includes the underlayment assembly 1 will choose either of the exemplary embodiments of the locking system 6, 6′.

If the user chooses locking system 6, the user will position the first panel 8 on a flat surface. The second panel 8 will be positioned on any of the open sides of the first panel 8 as the locking system 6 is positioned on any of the sides of the first panel 8. One skilled in the art would understand the applicant's design is not the exclusive embodiment.

The user will adjust the second panel 8 and position the lower tongue 62 against the first upper groove receiver 54 and the second upper groove receiver 56. Additionally, the upper tongue 52 will be positioned against the first lower groove receiver 64 and the second lower groove receiver 66. Moreover, the protrusion 58 will snap against the protrusion receiver 68 as shown in FIG. 7.

In another exemplary embodiment, when the user chooses the locking system 6′, the user will again position the first panel 8 on a flat surface. The second panel 8 will be positioned on any of the open sides of the first panel 8 as the locking system 6′ is positioned on any of the four sides of the first panel 8. One skilled in the art would understand the applicant's design is not the exclusive embodiment.

The user will adjust the second panel 8 and position the downward tongue 82 against the first upwards groove 74. Additionally, the upwards tongue 72 will be positioned against the first downward groove receiver 84. Moreover, the protrusion 86 will snap against the protrusion receiver 76 as shown in FIG. 8.

The composition of the rigid core layer 10 can be either a PVC-based polymer or a non-PVC polymer, such as a Polyurethane, Ethylene Vinyl Acetate, Olefin Polymers (including Polypropylene, Polyethylene or Ethylene copolymers), Polyester, and others. In the exemplary embodiment, a PVC-based polymer system is used, especially when considering the versatile properties, ease of manufacture and cost of the underlayment assembly 1.

In the exemplary embodiment, the composition of the upper surface section 2 is as follows in Table 1:

TABLE 1

| | Upper Surface | Upper Surface | Upper Surface |
|---|---|---|---|
| | Section #1 | Section #2 | Section #3 |
| Ingredients | Weight (PHR) | Weight (PHR) | Weight (PHR) |
| PVC Resin | 100 | 100 | 100 |
| Internal Lubricant | 0.7-1.5 | 1-1.2 | 1.05-1.15 |
| External Lubricant | 0.7-1.5 | 1-1.2 | 1.05-1.15 |
| Heat Stabilizer | 5-10 | 6.5-8.5 | 7-8 |
| Filler | 250-350 | 272-332.5 | 290-310 |
| Impact Modifier | 3-9 | 5-8 | 6-7 |
| Processing Aid | 1-6 | 2-5 | 3-4 |
| Regrinds | 110-350 | 180-300 | 200-220 |

In the exemplary embodiment, Table 1 displays an ingredient list of the upper surface section 2. In particular, Table 1 displays different ranges of ingredient percentages that may comprise the upper surface section 2. As displayed above in Table 1, the upper surface section 2 is generally composed of PVC Resin, an Internal Lubricant, an External Lubricant, a Heat Stabilizer, a Filler, an Impact Modifier, a Processing Aid and Regrinds.

In an exemplary embodiment of the invention, upper surface section 2 according to the invention is composed of a PVC Resin of 100 weight (PHR)). The upper surface section 2 according to the invention comprises an internal lubricant at about 0.7 to about 1.5 weight percentage (wt %). In another exemplary embodiment, the internal lubricant is at about 1 to about 1.2 weight percentage (wt %). In another exemplary embodiment, the internal lubricant is at about 1.05 to about 1.15 weight percentage (wt %). The upper surface section 2 according to the invention comprises an external lubricant at about 0.7 to about 1.5 weight percentage (wt %). In another exemplary embodiment, the external lubricant is at about 1 to about 1.2 weight percentage (wt %). In another exemplary embodiment, the external lubricant is at about 1.05 to about 1.15 weight percentage (wt %). The upper surface section 2 according to the invention comprises a heat stabilizer at about 5 to about 10 weight percentage (wt %). In another exemplary embodiment, the heat stabilizer is at about 6.5 to about 8.5 weight percentage (wt %). In another exemplary embodiment, the heat stabilizer is at about 7 to about 8 weight percentage (wt %). The upper surface section 2 according to the invention comprises a filler at about 250 to about 350 weight percentage (wt %). In another exemplary embodiment, the filler is at about 272 to about 332.5 weight percentage (wt %). In another exemplary embodiment, the filler is at about 290 to about 310 weight percentage (wt %). The upper surface section 2 according to the invention comprises am impact modifier at about 3 to about 9 weight percentage (wt %). In another exemplary embodiment, the impact modifier is at about 5 to about 8 weight percentage (wt %). In another exemplary embodiment, the impact modifier is at about 6 to about 7 weight percentage (wt %). The upper surface section 2 according to the invention comprises a processing aid at about 1 to about 6 weight percentage (wt %). In another exemplary embodiment, the processing aid is at about 2 to about 5 weight percentage (wt %). In another exemplary embodiment, the processing aid is at about 3 to about 4 weight percentage (wt %). The upper surface section 2 according to the invention comprises a regrinds at about 110 to about 350 weight percentage (wt %). In another exemplary embodiment, the heat stabilizer is at about 180 to about 300 weight percentage (wt %). In another exemplary embodiment, the heat stabilizer is at about 200 to about 220 weight percentage (wt %). The PVC resin in the compound is a suspension grade resin, which has a molecular weight per ASTM D5225 in the range of 0.89-0.95 (K value=67-68), a bulk density in the range of 0.47-0.56 grams/cc, and a particle size in the range of 100-150 microns. The most common stabilizers used for this application are calcium stearate, zinc stearate or a Calcium/Zinc combined complex soap with calcium/zinc complexed metal soap. One skilled in the art would understand the applicant's design is not the exclusive embodiment.

A lubricant system can be divided into an external lubricant and an internal lubricant, based on its functionality inside the extruder during the PVC melting stage. External lubricants migrate to the surface of the melt compound to prevent material sticking to the hot metal surface of the inner wall of the barrel and screw inside the extruder. The most common external lubricants are low molecular weight paraffin wax or polyethene wax etc. Because the presence of an external lubricant delays the fusion time of PVC, the transition from PVC powder flow to molecular melt flow will take longer.

Alternately, the internal lubricant improves the flow inside the extruder by lowering the melt viscosity of the PVC compound. Typical internal lubricants are comprised of fatty acids, esters, and alcohols. Metallic soaps, salts of stearic acid and other organic acids are commonly used as an internal lubricant and auxiliary heat stabilizer.

Processing aids play an essential role in PVC compounds and provide many unique features. Processing aids promote friction between hot processing surfaces and PVC compounds inside the extruder. They also alter the melt rheology of PVC compounds by increasing the melt strength and elasticity of the material, preventing the compound from tearing off when the extrudate comes out the extrusion die. They also promote fusion and increase homogeneity of PVC compounds. Several types of polymers are used for rigid PVC compounds. The most widely used are acrylate and methacrylate homopolymers or copolymers, such as polymethylmethacrylate, styrene-acrylic-ethyl acrylate, methylmethacrylate alkyl acrylate copolymer etc.

Impact modifiers are an important component of rigid PVC products, as they improve the impact strength of the material and prevent it from breaking or chipping when the product is subjected to high impacts at room temperature and/or low temperatures. They are particularly important for flooring products that have a mechanical locking tongue and groove design, as the locking profile is milled by high-speed spindles that are driven by motors. If the product doesn't have sufficient impact strength, then the product will fracture, chip, and break during the profiling process. Typical impact modifiers for rigid PVC are ABS, MBS, acrylics, CPE, and EVA etc.

Fillers are also an important ingredient in PVC compounds, as they reduce the overall raw material cost. They can also reinforce the rigidity and weight of the product. The most used fillers are clay, calcium carbonate, Calcium sulfate, kaolin etc.

### Performance Characteristics:

In the exemplary embodiment, an overall dimension of the testing specimen is 9 in.×60 in. One skilled in the art would understand the overall dimension can vary.

### Product Testing

The overall specimen includes a dimension of 9 in.×60 in. The overall thickness of the specimen is 4.6 mm. The overall thickness of the underlayment assembly 1 is 1 mm.

The ASTM D792-Density/Specific Gravity testing concluded a result of 1.69 kg/m³.

The ISO 24337-Joint Openings test included a passing criterion of ≤0.004 in. (0.1 mm) avg.≤0.008 in. (0.2 mm) per measurement. The testing concluded a result of a Max 0.121 mm and an Avg. 0.088 mm.

The ISO 24337-Joint Ledging test included a passing criterion of ≤0.004 in. (0.1 mm) avg.≤0.006 in. (0.15 mm) per measurement. The testing concluded a result of a Max 0.103 mm and an Avg. 0.083 mm.

The ISO 24337-Length & Width Flatness test included a passing criterion of +0.008 in. (0.2 mm) Max Width & Length: ≤+0.15%, ≤−0.20% avg. The testing concluded a result of a Width: with a Max −0.058% and an Avg. −0.039%. The testing concluded a result of a Length: with a Max −0.180% and an Avg. −0.012%.

The ASTM F2199-Dimensional Stability test included a passing criterion of 0.2%/lin. ft. avg. Max 0.080 in. (2 mm) Max Curl. The testing concluded a result of +0.00-+0.003/lin. ft. and a 0.76-1.27 mm Curl.

The ASTM F970-Static Load Limit test included a passing criterion of 250 lb., ≤0.005 in. (0.13 mm) Indentation. The testing concluded a result of a Max 400 lbs.

The ISO 4918-Castor Chair test included a passing criterion of ≥15,000 cycles. The testing concluded a result of 19,000 cycles.

The ASTM E648 (NFPA 253)—Critical Radiant Flux test included a passing criterion of Class 1: >0.45 W/cm2 and Class 2:0.22-0.44 W/cm2. The testing concluded a result for Class 1:0.95 W/cm2. The testing concluded a result for Class 2:

Testing with Flooring Products

In the exemplary embodiment, a testing specimen was used and composed of 2.5 mm of LVT, 0.8 mm acrylic pressure sensitive adhesive and a 4.6 mm underlayment assembly 1.

In another exemplary embodiment, a testing specimen was used and composed of 5.0 mm LLT, 0.8 mm acrylic pressure sensitive adhesive and a 4.6 mm underlayment assembly 1.

Chair Castor Resistance test. The test is designed to evaluate the durability of the locking mechanism when exposed to rolling loads from rolling chair castors/wheels. Rolling chairs are commonly found in residential and hospitality settings and rolling loads are known to cause locking mechanism over time. Locking mechanism damage can result in gapping (joint openings), buckling (ledging) or total locking mechanism failure (visible damage/pulverization). This test was performed in accordance with the ISO 4918 Resilient, Textile and Laminate Floor Coverings Castor Chair Test method using Type W castors.

In both the exemplary embodiments, the specimens were inspected every 5,000 cycles for joint openings, ledging and visible damage until 25,000 cycles are reached.

In both embodiments, if the test specimens did not experience any performance issues at the completion of the test, the test specimens were removed and inspected for any visual damage.

The test results in both the exemplary embodiments concluded a total of 25,000 cycles.

Indentation Resistance Test. The indentation resistance test is designed to measure the indentation of resilient flooring materials after 24 hours of exposure and recovery. Flexible products, such as LVT and LLT, are prone to indentation from heavy static loads, especially when a soft underlayment or substrate is installed directly below it. When used in conjunction with the relevant flooring specification, this test helps determine whether a floor covering will easily indent from normal furniture loads.

This test was performed in accordance with the ASTM F970 Standard Test Method for Measuring Recovery Properties of Floor Coverings after Static Loading. This test method uses a 1.125 in. diameter (1 sq. in.) indenter foot, which is intended to represent the typical size of furniture feet, and a 250 lb. load, which represents a 1,000 lb. piece of furniture. In both exemplary embodiments, the test specimens were evaluated after 24 hours of loading and 24 subsequent hours of recovery to measure the thickness of the product and total indentation.

The test results in both exemplary embodiments concluded a less than 0.005 in. indentation.

Structure-borne and Airborne Acoustical Testing. The test specimens were tested according to the following test methods: The ASTM E90 Standard Test Method for Laboratory Measurement of Airborne Sound Transmission Loss of Building Partitions and Elements, The ASTM E492 Standard Test Method for Laboratory Measurement of Impact Sound Transmission Through Floor-Ceiling Assemblies Using the Tapping Machine, The ASTM E2179 Standard Test Method for Laboratory Measurement of the Effectiveness of Floor Coverings in Reducing Impact Sound Transmission Through Concrete Floors.

The measurements for both exemplary embodiments from these sound tests were subsequently classified using the following standards: The ASTM E413 Classification for Rating Sound Insulation, The ASTM E989 Standard Classification for Determination of Single-Number Metrics for Impact Noise. The test specimens from both exemplary embodiments were installed in an ISO- and ASTM-compliant acoustical testing chamber over a 6 in. (152 mm) concrete slab.

The test results regarding the exemplary embodiment with LVT concluded the following ASTM E90/E413: STC 51. ASTM E492/E989: IIC 57, and ASTM E2179: ΔIIC 25.

The test results regarding the exemplary embodiment with LLT concluded ASTM E90/E413: STC 51, ASTM E492/E989: IIC 56, and ASTM E2179: AIIC 25.

Dimensional Stability test. The test is designed to measure the dimensional change that resilient flooring experiences when exposed to high heat and allowed to cool. Resilient flooring products, especially ones that contain PVC, are temperature-sensitive and tend to expand and contract when exposed to direct sunlight or when experiencing rapid and severe changes in temperature. When used in conjunction with the relevant flooring specification, this test helps determine whether a floor covering will excessively expand and/or contract, which can result in gapping, buckling and other unsightly issues. This test was performed in accordance with the ASTM F2199 Standard Test Method for Determining Dimensional Stability and Curling Properties of Resilient Flooring after Exposure to Heat. The test specimens were exposed to 180° F. (82° C.) via a mechanical convection oven for 6 hours, then reconditioned at room temperature for 24 hours prior to measurement.

It was concluded in both exemplary embodiments a less than 0.5 mm of change/lin. ft.

It should be noted that various changes and modifications to the embodiments described herein will be apparent to those skilled in the art. Such changes and modifications may be made without departing from the spirit and scope of the present invention and without diminishing its intended advantages. For example, various embodiments of the systems and methods may be provided based on various combinations of the features and functions from the subject matter provided herein.

What is claimed is:

1. An underlayment assembly comprising:
an upper surface section with a top surface, the top surface having an embossed texture with an embossed depth positioned on the upper surface section;
an acoustical section having an acoustical layer secured to a bottom portion of the upper surface section by an adhesive layer, the acoustical layer having a cell structure underlayment with a closed cell honeycomb structure; and
a locking system having a first coupling part and a second coupling part.

2. The underlayment assembly of claim 1, wherein the upper surface section is a polymeric rigid core.

3. The underlayment assembly of claim 2, wherein the polymeric rigid core includes a composition of a polyvinyl chloride (PVC) resin, a stabilizer, an impact modifier, a processing aid and a calcium carbonate filler.

4. The underlayment assembly of claim 3, wherein the acoustical layer is secured to a lower surface of the upper surface section by the adhesive layer at an application rate of about 60 to about 70 gram/m².

5. The underlayment assembly of claim 4, wherein the acoustical layer is secured to the lower surface of the upper surface section by the adhesive layer at an application rate of about 64 to about 65.5 gram/m².

6. The underlayment assembly of claim 5, wherein the acoustical layer has a thickness of 1 mm or less that accounts for 30% of a total laminated product thickness of the underlayment assembly.

7. The underlayment assembly of claim 5, wherein the acoustical layer has a thickness has a thickness of 0.95 mm or less that accounts for 30% of the total laminated product thickness of the underlayment assembly.

8. The underlayment assembly of claim 5, wherein the acoustical layer has a thickness of 0.95 mm or less that accounts for 30% of the total laminated product thickness of the underlayment assembly.

9. The underlayment assembly of claim 8, wherein a density of the acoustical layer is in the of about 5 lb./ft³ (0.08 g/cc) to about 20 lb./ft³ (0.32 g/cc).

10. The underlayment assembly of claim 9, wherein a thickness of the acoustical layer is in the range of about 1 mm to about 2 mm.

11. The underlayment assembly of claim 3, wherein the pvc resin is a suspension grade resin.

12. The underlayment assembly of claim 3, wherein the pvc resin has a molecular weight per ASTM D5225 in the range of 0.89-0.95.

13. The underlayment assembly of claim 3, wherein the pvc resin has a bulk density in the range of 0.47-0.56 grams/cc.

14. The underlayment assembly of claim 3, wherein the pvc resin has a particle size in the range of 100-150 microns.

15. The underlayment assembly of claim 10, wherein the upper surface section includes a rigid core layer.

16. The underlayment assembly of claim 11, wherein the rigid core layer has a thickness in the range of 3.0 mm to 8 mm.

17. The underlayment assembly of claim 12, wherein the rigid core layer has a thickness in the range of 4.0-5.0 mm.

18. The underlayment assembly of claim 1, wherein the first coupling part includes an upper tongue, a first upper groove receiver, a second upper groove receiver and a protrusion.

19. The underlayment assembly of claim 18, wherein the second coupling part includes a lower tongue, a first lower groove receiver, a second lower groove receiver and a protrusion receiver.
